(19) United States
(12) Patent Application Publication
(10) Pub. No.: US 2022/0222859 A1
(43) Pub. Date: Jul. 14, 2022

(54) DIFFERENCE DETECTION APPARATUS, DIFFERENCE DETECTION METHOD, AND PROGRAM

(71) Applicant: NIPPON TELEGRAPH AND TELEPHONE CORPORATION, Tokyo (JP)

(72) Inventors: Motohiro TAKAGI, Musashino-shi, Tokyo (JP); Kazuya HAYASE, Musashino-shi, Tokyo (JP); Takayuki DNISHI, Musashino-shi, Tokyo (JP); Atsushi SHIMIZU, Musashino-shi, Tokyo (JP)

(73) Assignee: NIPPON TELEGRAPH AND TELEPHONE CORPORATION, Tokyo (JP)

(21) Appl. No.: 17/595,182

(22) PCT Filed: May 30, 2019
(86) PCT No.: PCT/JP2019/021465

§ 371 Date: Nov. 10, 2021

(51) Int. Cl. G06T 7/00

(52) U.S. Cl. CPC G06T 7/97; G06T 2207/20084; G06T 2207/20076; G06T 2207/20224

(57) ABSTRACT

A difference detection apparatus includes: an acquisition unit configured to acquire a difference level indicating a level of a difference between a first image that is an image of a first spatial region and a second image that is an image of a second spatial region located at a substantially same position as the first spatial region, first probability data indicating a probability that a target object is present in the first spatial region, and second probability data indicating a probability that the target object is present in the second spatial region; and a detection unit configured to associate the difference level, the first probability data, and the second probability data, and detect, based on a result of the association, a region where a difference occurs between the first image and the second image.

### TECHNICAL FIELD

The present invention relates to a difference detection apparatus, a difference detection method, and a program.

### BACKGROUND ART

A satellite or an aircraft may capture images of a spatial region at substantially the same location on the ground at different time points. Changes over time in terms of presence/absence of a target object in the spatial region of which images have been captured is detected, by detecting in the images the region (hereinafter, referred to as a “difference region”) with a difference between the images depending on whether there is the target object in the spatial region of which images are captured at different times.

The detection of the difference region in the image leads to a detection of a building (hereinafter, referred to as a “new building”) newly built on the ground, for example. Here, a person performs visual comparison between images captured at different time points and detects the new building indicated by the difference region in the image. When the new building is detected for updating a map, for example, a person performs visual comparison among a huge number of time-series images. Since a person compares a huge number of images, a high time cost and a high labor cost are required.

For reducing such time and labor costs, a technique that allows a difference detection apparatus to detect the difference region based on machine learning using a neural network has been proposed (see Non Patent Literature 1). According to Non Patent Literature 1, the difference detection apparatus detects a difference region between images of a spatial region captured at different time points. The difference detection apparatus generates difference region data indicating the difference region detected.

### CITATION LIST

### Non Patent Literature

Non Patent Literature 1: R. C. Daudt, B. L. Saux, and A. Boulch, “Fully Convolutional Siamese Networks for Change Detection,” in 2018 IEEE International Conference on Image Processing, ICIP 2018, Athens, Greece, Oct. 7 to 10, 2018, pp. 4063 to 4067, 2018.

### SUMMARY OF THE INVENTION

### Technical Problem

Unfortunately, the difference detection apparatus might erroneously detect regions that are not the difference region between the images as the difference region between images. For example, the difference detection apparatus might erroneously detect a region of an existing building of which roof is recolored as a difference region caused by the presence of a new building. Thus, the difference region between images might not be detected with high accuracy.

In view of the above, an object of the present invention is to provide a difference detection apparatus, a difference detection method, and a program, which can improve the accuracy of detection of the difference region between images.

### Means for Solving the Problem

One aspect of the present invention is a difference detection apparatus including: an acquisition unit configured to acquire a difference level indicating a level of a difference between a first image that is an image of a first spatial region and a second image that is an image of a second spatial region located at a substantially same position as the first spatial region, first probability data indicating a probability that a target object is present in the first spatial region, and second probability data indicating a probability that the target object is present in the second spatial region; and a detection unit configured to associate the difference level, the first probability data, and the second probability data, and detect, based on a result of the association, a region where a difference occurs between the first image and the second image.

One aspect of the present invention is a difference detection apparatus including: a first region mask unit configured to generate a first probability image that is an image obtained as a result of mask processing performed on a first image that is an image of a first spatial region by using, as a mask image, first probability data that is prepared in advance and indicates a probability that a target object is present in the first spatial region; a second region mask unit configured to generate a second probability image that is an image obtained as a result of mask processing performed on a second image that is an image of a second spatial region located at a substantially same position as the first spatial region by using, as a mask image, second probability data that indicates an estimated value of a probability that the target object is present in the second spatial region; and a detection unit configured to associate the first probability data and the second probability data, and detect, based on a result of the association, a region where a difference occurs between the first image and the second image.

### Effects of the Invention

The present invention can improve the accuracy of detection of a difference region between images.

### BRIEF DESCRIPTION OF DRAWINGS

FIG. 1 is a diagram illustrating an example of a configuration of a difference detection apparatus according to a first embodiment.

FIG. 2 is a diagram illustrating an example of how second difference region data is generated according to the first embodiment.

FIG. 3 is a flowchart illustrating an example of an estimation operation performed by the difference detection apparatus according to the first embodiment.

FIG. 4 is a flowchart illustrating an example of an estimation operation performed by a first region detection unit according to the first embodiment.

FIG. 5 is a flowchart illustrating an example of an estimation operation performed by a first attribute detection unit according to the first embodiment.

FIG. 6 is a flowchart illustrating an example of an estimation operation performed by a second region detection unit according to the first embodiment.

FIG. 7 is a diagram illustrating an example of a configuration of a first learning apparatus according to the first embodiment.

FIG. 8 is a diagram illustrating an example of a configuration of an attribute learning apparatus according to the first embodiment.

FIG. 9 is a diagram illustrating an example of a configuration of a second learning apparatus according to the first embodiment.

FIG. 10 is a flowchart illustrating an example of an estimation operation performed by the second region detection unit according to a modified example of the first embodiment.

FIG. 11 is a diagram illustrating an example of a configuration of a difference detection apparatus according to a second embodiment.

FIG. 12 is a diagram illustrating an example of a configuration of a difference detection apparatus according to a third embodiment.

FIG. 13 is a flowchart illustrating an example of an operation performed by a first region mask unit according to the third embodiment.

FIG. 14 is a flowchart illustrating an example of an operation performed by a second region mask unit according to the third embodiment.

FIG. 15 is a flowchart illustrating an example of an estimation operation performed by a third region detection unit according to the third embodiment.

### DESCRIPTION OF EMBODIMENTS

Embodiments of the present invention will be described in detail with reference to the drawings.

### First Embodiment

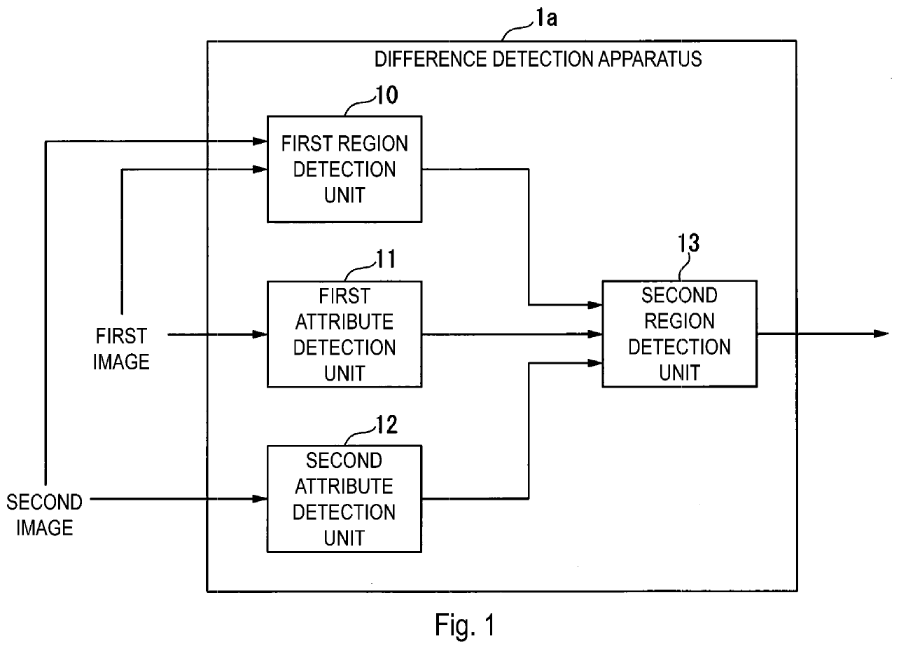

FIG. 1 is a diagram illustrating an example of a configuration of a difference detection apparatus 1a. The difference detection apparatus 1a is an information processing apparatus that detects a difference region between images. The difference region between images appears depending on the presence/absence of a target object in a spatial region captured in the images at different time points. Examples of the target object (subject) in a captured image include a building, a road, and the like. The captured image may be a still image or a movie. The captured image has a rectangular-shaped frame, for example. The difference detection apparatus 1a detects a difference region between images with, for example, a model using a neural network.

When the difference detection apparatus 1a detects a difference region using a model using a neural network, the operation stage of the difference detection apparatus 1a includes a learning phase and an estimation phase. In the learning phase, an information processing apparatus (learning apparatus) implements machine learning on a model used in the difference detection apparatus 1a. In the estimation phase, the difference detection apparatus 1a uses the trained model to detect a difference region between images.

The difference detection apparatus 1a includes a first region detection unit 10, a first attribute detection unit 11, a second attribute detection unit 12, and a second region detection unit 13. The first attribute detection unit 11 is provided on an upstream side of the second region detection unit 13 in a data flow.

A processor such as a central processing unit (CPU) executes a program stored in a memory which is a nonvolatile recording medium (non-transitory recording medium), and thus, a part or all of the difference detection apparatus is realized as software. The program may be recorded in a computer-readable recording medium. The computer-readable recording medium is, for example, a portable medium such as a flexible disk, a magneto-optical disk, a read only memory (ROM), or a compact disc read only memory (CD-ROM), or a non-transitory storage medium such as a storage device such as a hard disk drive built into a computer system. The program may be transmitted via an electrical communication line. A part or all of the difference detection apparatus may be realized by using hardware including an electronic circuit (or circuitry) using a large scale integration circuit (LSI), an application specific integrated circuit (ASIC), a programmable logic device (PLD), or a field programmable gate array (FPGA), for example.

The first region detection unit 10 acquires a first image and a second image. The first image and the second image are two of a group of images of spatial regions of substantially the same location captured at different time points. The first image is, for example, an image (past image) of a region captured from the sky by a satellite, an aircraft, or the like in the past. The second image is an image (current image) of substantially the same region captured from the sky by a satellite, an aircraft, or the like, for example, at a time point closer to the current time than the shooting time of the first image. The size of the first image is, for example, the same as the size of the second image.

In the trained model (first region model) held in the first region detection unit 10, the first image and the second image are used as input to generate first difference region data (output of the first region model). The first region detection unit 10 may use the first image and the second image divided into a plurality of regions as input to generate the first difference region data for each of the regions. The first region detection unit 10 outputs the first difference region data to the second region detection unit 13.

The first difference region data is matrix data with each element indicating a level of difference (difference level) in pixel value between the first image and the second image. The level of difference in pixel value between images represents, in a pixel-by-pixel basis, the probability that a target object on the ground in the captured image is changing over time.

The first difference region data (change mask image) is expressed in a form of an image with pixels corresponding to the elements in the matrix data. The size of the first difference region data is the same as the size of each of the first image and the second image. The pixels of the first difference region data are associated with pixels of the same coordinates in the first image and the second image.

A value in the first difference region data represents the level of a difference (difference level) in pixel value between the first image and the second image. The difference level is estimated for each element of the matrix (pixel of the image) as a level of change in pixel value between the first image and the second image. The difference level is in a range from 0 to 1. Specifically, a value in the first difference region data represents the probability that the target object on the ground in a captured image changes over time between the shooting time of the first image and the shooting time of the second image. The probability value is in a range from 0 to 1. An integer part of a result of conversion processing executed on the probability value can be used as a pixel value of first difference region data expressed in a form of an image or the like. In the conversion processing executed on the probability value (hereinafter, referred to as “image conversion processing”), a result of multiplying the probability value by a predetermined value (255, for example) is obtained as a pixel value, for example.

As the probability value becomes closer to 1, the value of the first difference region data is expressed with a color (brighter color) close to white, for example, as a result of the image conversion processing. As the probability value becomes closer to 0, the value of the first difference region data is expressed with a color (darker color) close to black, for example, as a result of the image conversion processing.

The first attribute detection unit 11 acquires the first image (the past image). In the trained model (first attribute model) held in the first attribute detection unit 11, the first image is used as input to generate first attribute data (output of the first attribute model). The first attribute detection unit 11 may use the first image divided into a plurality of regions as input to generate the first attribute data for each of the regions. The first attribute detection unit 11 outputs the first attribute data to the second region detection unit 13.

The first attribute data (first probability data) is matrix data with each element indicating the probability that the pixel of the first image represents a target object. The probability that the pixel of a first image represents a target object is obtained for each pixel, for example, based on map data.

The trained model held in the first attribute detection unit 11 is a model trained based on map data prepared separately. The map data indicates the location (presence/absence) of the target object in the captured image of a spatial region. The first attribute detection unit 11 obtains, for each pixel, the probability that a pixel of the first image indicates the target object as an output of the model trained using the map data, regardless of the color or the like of the target object in the first image.

The first attribute data (attribute mask image) is expressed in a form of an image with pixels corresponding to elements in the matrix data, for example. An integer part of a result of multiplying the probability value by a predetermined value (255, for example) can be used as a pixel value. The size of the first attribute data is the same as the size of the first image. The pixels of the first attribute data are associated with pixels of the same coordinates in the first image. The pixel value of the pixel of the first attribute data increases as the probability that the pixel indicates a target object increases. In other words, the pixel value of the pixel of the first attribute data increases as the provability that the pixel is associated with the position of the target object increases.

When the target object is a building, for example, the probability value of the element that is not associated with the location of the building in the first attribute data is 0. The probability value of the element that is associated with the location of the building in the first attribute data is 1. When the map data is expressed in a form of an image, as the probability value becomes close to 1, the pixel of the map data is expressed with a color (brighter color) close to white, for example, as a result of the image conversion processing. As the probability value becomes close to 0, the pixel value of the map data is expressed with a color (darker color) close to black, for example, as a result of the image conversion processing.

The second attribute detection unit 12 acquires the second image (current image). A trained model (second attribute model) held in the second attribute detection unit 12 uses the second image as input to generate second attribute data (output of the second attribute model). The second attribute detection unit 12 may use the second image divided into a plurality of regions as input to generate the second attribute data for each of the regions. The second attribute detection unit 12 outputs the second attribute data to the second region detection unit 13.

The second attribute data (second probability data) is matrix data having, as each element, the probability that the pixel of the second image is a pixel indicating the target object. The probability that a pixel of a second image is a pixel indicating a target object is obtained for each pixel, for example, based on the map data.

Note that, depending on the purpose of detecting the difference region (for example, for detecting a new building or for detecting a new road), each probability indicating a plurality of types of target objects (for example, buildings and roads) may be obtained from the first attribute data and the second attribute data.

The trained model held in the second attribute detection unit 12 is a model trained based on map data prepared separately. The second attribute detection unit 12 obtains, for each pixel, the probability that a pixel of the second image indicates a target object as an output of a model trained using the map data, regardless of the color or the like of the target object in the second image.

The second attribute data (attribute mask image) is expressed in an image format with pixels corresponding to elements in the matrix data, for example. An integer part of a result of multiplying the probability value by a predetermined value (255, for example) can be used as a pixel value. The size of the second attribute data is the same as the size of the second image. The pixels of the second attribute data are associated with pixels of the same coordinates in the second image. The pixel value of the pixel of the second attribute data increases as the probability that the pixel indicates the target object increases. In other words, the pixel value of the pixel of the second attribute data increases as the provability that the pixel is associated with the position of the target object increases.

As in the case with the first attribute data, the probability value of an element that is not associated with the location of a building in the second attribute data is 0. The probability value of an element that is associated with the location of the building in the second attribute data is 1.

The second region detection unit 13 acquires the first difference region data, the first attribute data, and the second attribute data. The second region detection unit 13 combines the first difference region data, the first attribute data, and the second attribute data.

A trained model (second region model) held in the second region detection unit 13 uses the first difference region data, the first attribute data, and the second attribute data as input to generate second difference region data (output of the second region model). The second region detection unit 13 may use the first difference region data, the first attribute data, and the second attribute data divided into a plurality of regions as input to generate the second difference region data for each of the regions. The second region detection unit 13 outputs the second difference region data to a predetermined external apparatus (for example, an image recognition apparatus).

The second difference region data is matrix data with elements corresponding to respective pixels in the first difference region data. The second difference region data is expressed in a form of an image in which a pixel indicates each element of the matrix data for example. An integer part of a result of multiplying the probability value by a predetermined value (255, for example) can be used as a pixel value. That is, the second difference region data can be used as a change mask image in processing executed on a downstream side of the second region detection unit 13. The size of the second difference region data is the same as the size of each of the first image and the second image. The pixels of the second difference region data are associated with pixels of the same coordinates in the first difference region data and pixels of the same coordinates in the first image and the second image.

The second difference region data is data representing the probability of a target object changing in the spatial region, based on a combination of: the probability that feature data obtained only from a captured image of the target object in the spatial region is changing; and the probability that attribute (target object) data obtained using map data of substantially the same spatial region is changing. Also, the second difference region data is expressed in a form of an image, and thus is expressed with pixel values that is expressed with a color close to black as the probability that the target object is changing decreases. Thus, the second difference region data is usable as a mask image (change mask image) in which the pixels without a change in the target object are black, for example.

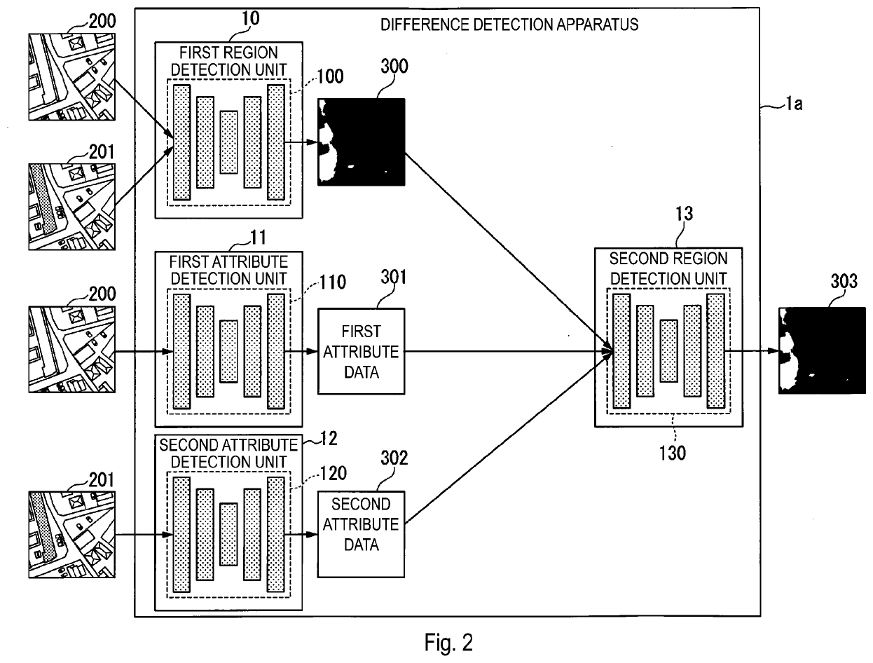

FIG. 2 is a diagram illustrating an example of how the second difference region data (change mask image) is generated. The first region detection unit 10 includes a first region model 100. The first attribute detection unit 11 includes a first attribute model 110. The second attribute detection unit 12 includes a second attribute model 120. The second region detection unit 13 includes a second region model 130.

The first region detection unit 10 acquires a first image 200 and a second image 201. The first region model 100 generates first difference region data 300 using the first image 200 and the second image 201 as input. The first region detection unit 10 outputs the first difference region data 300 to the second region detection unit 13.

The first attribute detection unit 11 acquires the first image 200. The first attribute model 110 generates first attribute data 301 (past attribute data) using the first image 200 (past image) as input. In the first attribute data 301, a region of the target object in the first image 200 is expressed based on map data. The first attribute detection unit 11 outputs the first attribute data 301 to the second region detection unit 13.

The second attribute detection unit 12 acquires the second image 201. The second attribute model 120 generates second attribute data 302 (current attribute data) using the second image 201 (current image) as input. In the second attribute data 302, a region of the target object in the second image 201 is expressed based on the map data. The second attribute detection unit 12 outputs the second attribute data 302 to the second region detection unit 13.

The second region detection unit 13 acquires the first difference region data, the first attribute data, and the second attribute data. The second region model 130 uses the combination of the first difference region data 300, the first attribute data 301, and the second attribute data 302 as input.

The second region model 130 held in the second region detection unit 13 changes each pixel value (each probability value) of the first difference region data 300 in accordance with a difference between the first attribute data 301 and the second attribute data 302. The second region model 130 detects a region where the difference between the first attribute data 301 and the second attribute data 302 is large (for example, a region where the difference is equal to or larger than a threshold) as the difference region in the first difference region data 300.

Note that the second region detection unit 13 may change each pixel value (each probability value) of the first difference region data 300 based on a result of comparison between the threshold and a difference level between the first attribute data 301 and the second attribute data 302.

The second region model 130 reduces each pixel value of the first difference region data 300 associated with a region where a difference level between the first attribute data 301 and the second attribute data 302 is low. For example, if the pixel value of the first difference region data 300 indicates a probability of being a new building, the second region model 130 detects, in the first difference region data 300, a pixel (pixel in a region where the difference level is low) associated with the location of the building in both of the first attribute data 301 and the second attribute data 302.

A pixel with substantially the same pixel value at substantially the same location in both the first attribute data 301 and the second attribute data 302 is likely to be a pixel representing a building (existing building) other than a new building. Thus, the second region model 130 reduces the pixel value of each pixel detected in the first difference region data 300 (for example, a probability value representing a probability of being a new building).

In this manner, the second region detection unit 13 detects, as the difference region, a region in the first difference region data 300 where the difference between the first attribute data and the second attribute data is large. The second region detection unit 13 detects, as the difference region, a region with a large pixel value (a region with a large difference level, a region with a difference level equal to or larger than a predetermined value) in the first difference region data 300.

To a predetermined external apparatus (for example, an image recognition apparatus), the second region detection unit 13 outputs, as second difference region data 303, the first difference region data 300 including pixel values changed in accordance with the difference level between the first attribute data and the second attribute data.

In this way, the second region detection unit 13 detects the difference region between the captured images based on both of: whether the target object at the same location in the past and current maps has changed over time; and a change over time in the captured image of a region indicated by the map data. For example, even in a case where the color of the roof of an existing building changes over time, a risk of the first region detection unit 10 erroneously detecting the existing building as a new building can be reduced, based on a fact that the map data (teacher data for the attribute data) used for training the first attribute model 110 and the second attribute model 120, does not have a time series change in the existing building.

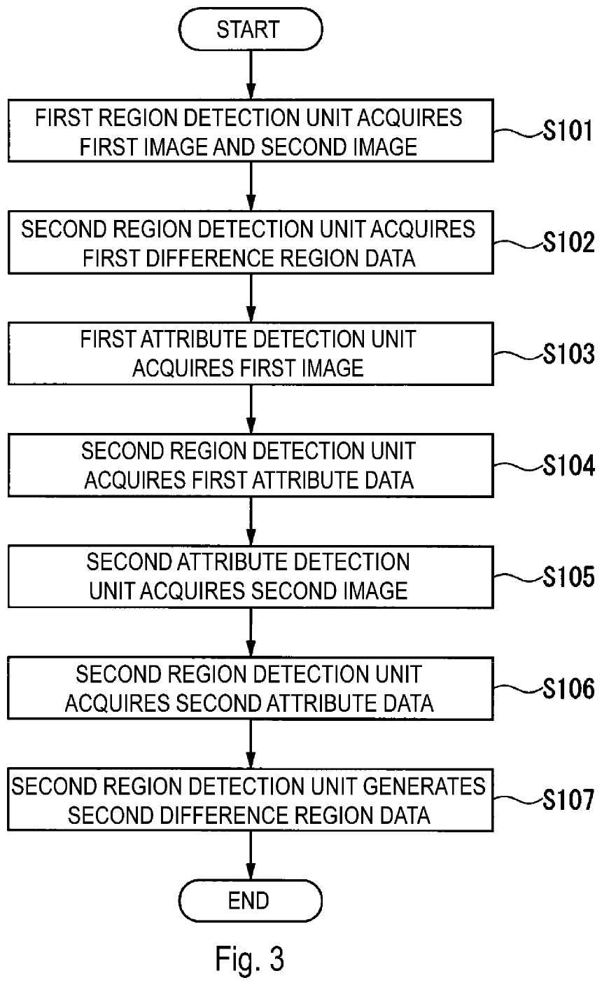

Next, an example of an estimation operation performed by the difference detection apparatus 1a in the estimation phase will be described. FIG. 3 is a flowchart illustrating an example of the estimation operation performed by the difference detection apparatus 1a. The first region detection unit 10 acquires the first image 200 and the second image 201, which are difference detection targets. The first region detection unit 10 generates the first difference region data 300 based on the first image 200 and the second image 201 (step S101) The second region detection unit 13 acquires the first difference region data 300 (step S102).

The first attribute detection unit 11 acquires the first image 200 (past image). The first attribute detection unit 11 generates the first attribute data 301 (past attribute data) based on the first image 200 (step S103). The second region detection unit 13 acquires the first attribute data 301 (step S104). The second attribute detection unit 12 acquires the second image 201 (current image). The second attribute detection unit 12 generates the second attribute data 302 (current attribute data) based on the second image 201 (step S105).

The second region detection unit 13 acquires the second attribute data 302 (step S106). The second region detection unit 13 generates the second difference region data 303 based on the combination of the first difference region data, the first attribute data, and the second attribute data (step S107).

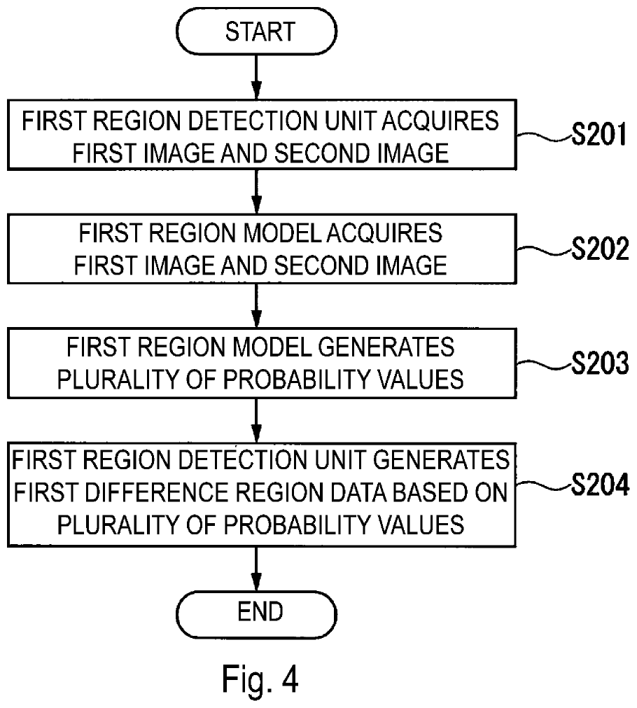

FIG. 4 is a flowchart illustrating an example of the estimation operation performed by the first region detection unit 10. In step S101 illustrated in FIG. 3, the first region detection unit 10 acquires the first image 200 and the second image 201 (step S201). The trained first region model 100 held in the first region detection unit 10 acquires the first image 200 and the second image 201 (step S202).

The first region model 100 generates a plurality of probability values (output of the first region model 100) using the pixel values of the first image 200 and the second image 201 as input of the first region model 100. The number of probability values generated is equal to the number (size) of pixels of the first image 200, for example (step S203). The first region model 100 generates the first difference region data 300 based on the plurality of probability values (output of the first region model 100). The first region detection unit 10 outputs the first difference region data 300 to the second region detection unit 13 (step S204).

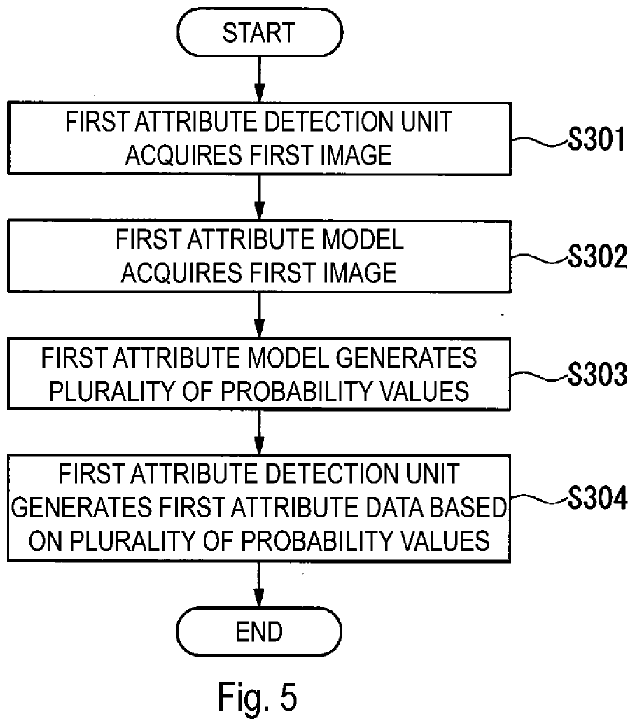

FIG. 5 is a flowchart illustrating an example of the estimation operation performed by the first attribute detection unit 11. In step S103 illustrated in FIG. 3, the first attribute detection unit 11 acquires the first image 200 (step S301). The trained first attribute model 110 held in the first attribute detection unit 11 acquires the first image 200 (step S302).

The first attribute model 110 generates a plurality of probability values (output of the first attribute model 110) using the pixel values of the first image 200 as input of the first attribute model 110. The number of probability values generated is equal to the number of pixels (size) of the first image 200 (step S303). The first attribute model 110 generates the first attribute data 301 based on the plurality of probability values (output of the first attribute model 110). The first region model 100 outputs the first attribute data 301 to the second region detection unit 13 (step S304).

The estimation operation performed by the second attribute detection unit 12 using the second image 201 in step S105 illustrated in FIG. 3 is similar to the estimation operation performed by the first attribute detection unit 11 using the first image 200 as illustrated in FIG. 5.

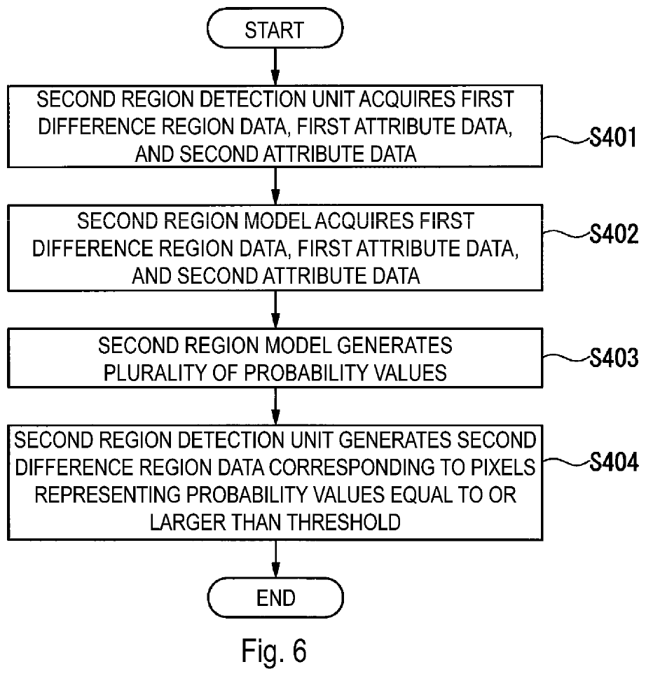

FIG. 6 is a flowchart illustrating an example of the estimation operation performed by the second region detection unit 13. The second region detection unit 13 acquires the first difference region data 300, the first attribute data 301, and the second attribute data 302 (step S401). The trained second region model 130 held in the second region detection unit 13 acquires the first difference region data 300, the first attribute data 301, and the second attribute data 302 (step S402).

The second region model 130 generates a plurality of probability values (output of the second region model 130) using the pixel values of the first difference region data 300, the first attribute data 301, and the second attribute data 302 as input of the second region model 130. The number of probability values thus generated is equal to the number of pixels (size) of the first difference region data 300, for example (step S403).

The second region detection unit 13 detects each pixel indicating a pixel value equal to or larger than the threshold, in the first difference region data 300. The range of thresholds for pixel values may be selected from among the pixel values from the pixel value corresponding to the difference level “0” (for example, 0) to the pixel value corresponding to the difference level “1” (for example, 255), depending on the accuracy of the model. The second region detection unit 13 generates the second difference region data 303 (change region data) corresponding to each pixel detected (step S404).

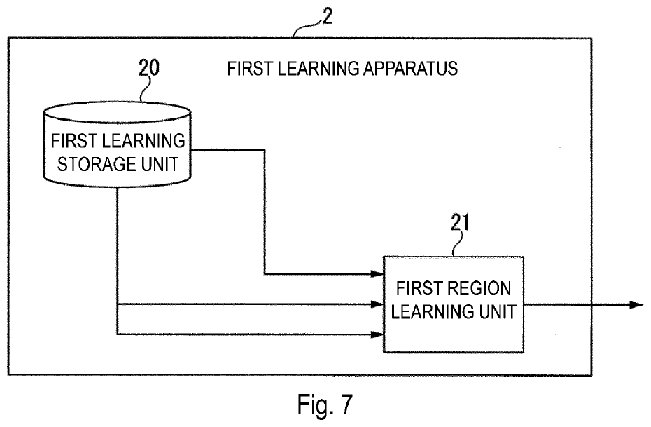

Next, an example of a machine learning operation performed by the learning apparatus in the learning phase will be described. FIG. 7 is a diagram illustrating an example of a configuration of a first learning apparatus 2. The first learning apparatus 2 is an information processing apparatus that generates, through machine learning, the first region model 100 held in the first region detection unit 10.

The first learning apparatus 2 includes a first learning storage unit 20 and a first region learning unit 21. A processor such as a CPU executes a program stored in a memory which is a nonvolatile recording medium (non-transitory recording medium), and thus, a part or all of the first learning apparatus 2 is realized as software. The program may be recorded in a computer-readable recording medium. A part or all of the first learning apparatus 2 may be realized by hardware including an electronic circuit using an LSI, ASIC, PLD, or FPGA, for example.

The first learning storage unit 20 stores a learning image group including a first learning image and a second learning image, and map data. The learning image group is a group of images for machine learning. The first learning image and the second learning image are a set of images that represent a spatial region at substantially the same location on the ground captured from the sky at different time points.

The map data is electronic map data that indicates the locations of target objects, such as a house and a wall free house, with an arrangement of polygons. The map data may include location data on the target object in a form of data (layer data) representing the target object for each layer associated with a type of the target object.

Note that in the map data, the locations of the target objects may be indicated with an arrangement of images representing shapes of the target objects, instead of using the polygons, as long as the locations of the target objects can be accurately indicated.

The first learning storage unit 20 stores the teacher data (referred to hereinafter as “first region teacher data”) for the first difference region data. The first learning image, the second learning image, the map data, and the first region teacher data are associated with each other in terms of a location and a time point of the spatial region.

The first region teacher data is prepared in advance using the map data. For example, the first region teacher data is data indicating a location of the target object present in only one of the first map data and the second map data on the spatial region at substantially the same location, using an arrangement of polygons or images. The location of the target object present in only one of the first map data and the second map data is the location of the target object in the difference region and is, for example, the location of a new building.

The model held in the first region learning unit 21 is a model comprising a network similar to a fully convolution network, such as a U-Net that holds an encoder and a decoder. The encoder encodes data through repetition of a convolutional layer and a pooling layer. The decoder decodes data through repetition of an upsampling layer, a reverse convolutional layer, and a pooling layer. The network structure of the model held in the first region learning unit 21 may be, for example, a structure similar to the network structure described in Non Patent Literature 1. The model held in the first region learning unit 21 may include two encoders and a single decoder.

In the learning phase, the first region learning unit 21 acquires the first learning image, the second learning image, and the first region teacher data. The model held in the first region learning unit 21 outputs estimated data (estimated change mask image) on the first difference region data 300, using, as input, the first learning image and the second learning image (set of learning images) and the first region teacher data.

The first region learning unit 21 updates the parameters of the network of the model held in the first region learning unit 21 to minimize an evaluation error between the estimated data on the first difference region data 300 and the first region teacher data. The evaluation error is, for example, a loss function such as binary cross-entropy, mean absolute error (MAE), or mean squared error.

The first region learning unit 21 updates the parameters using, for example, a back propagation method. The first region learning unit 21 outputs the model with updated network parameters to the first region detection unit 10 as the first region model 100.

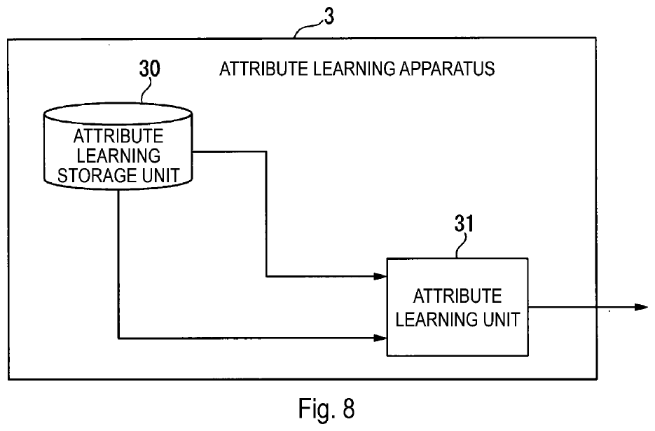

FIG. 8 is a diagram illustrating an example of a configuration of an attribute learning apparatus 3. The attribute learning apparatus 3 is an information processing apparatus that generates, through machine learning, the first attribute model 110 held in the first attribute detection unit 11. The attribute learning apparatus 3 may generate, through machine learning, not only the first attribute model 110 held in the first attribute detection unit 11, but also the second attribute model 120 held in the second attribute detection unit 12.

The attribute learning apparatus 3 includes an attribute learning storage unit 30 and an attribute learning unit 31. A processor such as a CPU executes a program stored in a memory which is a nonvolatile recording medium (non-transitory recording medium), and thus, a part or all of the attribute learning apparatus 3 is realized as software. The program may be recorded in a computer-readable recording medium. A part or all of the attribute learning apparatus 3 may be realized by hardware including an electronic circuit using an LSI, ASIC, PLD, or FPGA, for example.

The attribute learning storage unit 30 stores a learning image group and map data. The attribute learning unit 31 stores teacher data (hereinafter, referred to as “attribute teacher data”) for the first attribute data or the second attribute data. The attribute teacher data is prepared in advance using the map data. The attribute teacher data is matrix data with elements being the probability of respective pixel values of a learning image indicating the attribute of the target object. For example, the attribute teacher data is matrix data with elements being the probability of respective pixel values of a learning image indicating a building. The learning image group, the map data, and the attribute teacher data are associated with each other in terms of a location and a time point of the spatial region.

The model held in the attribute learning unit 31 is a model provided with a network similar to a fully convolutional network, such as a U-Net that holds an encoder and a decoder. The network structure of the model held in the attribute learning unit 31 may be, for example, a structure similar to the network structure described in Non Patent Literature 1.

In the learning phase, the attribute learning unit 31 acquires the learning image (past learning image) in the learning image group and the attribute teacher data. The model held in the attribute learning unit 31 uses the learning image and the attribute teacher data as input, and outputs the estimated data (estimated attribute mask image) on the first attribute data 301.

The attribute learning unit 31 updates the parameters of the network of the model held in the attribute learning unit 31 to minimize the evaluation error between the estimated data on the first attribute data 301 and the attribute teacher data. The attribute learning unit 31 updates the parameters using, for example, a back propagation method. The attribute learning unit 31 outputs the model for which the parameters of the network have been updated, to the first attribute detection unit 11, as the first attribute data 301.

The model held in the attribute learning unit 31 may use the attribute teacher data and a learning image (current learning image) newer than the past learning image used for generating estimated data on the first attribute data 301 as input to output estimated data (estimated attribute mask image) on the second attribute data 302. The attribute learning unit 31 may output the model for which the parameters of the network have been updated, to the second attribute detection unit 12, as the second attribute data 302.

The model generated by the attribute learning unit 31 using the past learning image can detect the target object in the current learning image. Thus, the attribute learning unit 31 may output, as the second attribute model 120, a model trained using a learning image group (past learning image group) used for generating the first attribute model 110, to the second attribute detection unit 12.

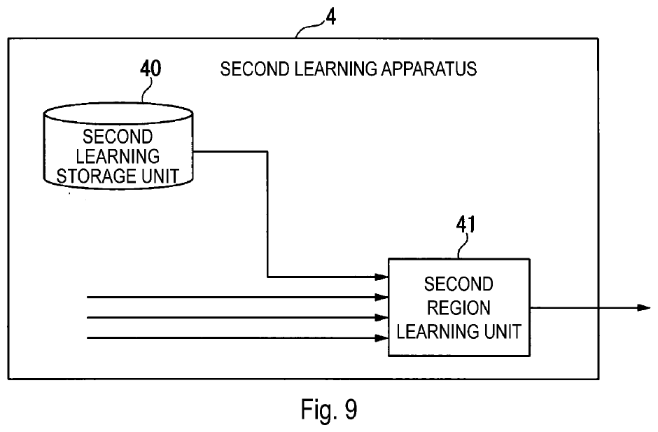

FIG. 9 is a diagram illustrating an example of a configuration of a second learning apparatus 4. The second learning apparatus 4 is an information processing apparatus that generates, through machine learning, the second region model 130 held in the second region detection unit 13.

The second learning apparatus 4 includes a second learning storage unit 40 and a second region learning unit 41. A processor such as a CPU executes a program stored in a memory which is a nonvolatile recording medium (non-transitory recording medium), and thus, a part or all of the second learning apparatus 4 is realized as software. The program may be recorded in a computer-readable recording medium. A part or all of the second learning apparatus 4 may be realized by hardware including an electronic circuit using an LSI, ASIC, PLD, or FPGA, for example.

The second learning storage unit 40 stores the teacher data (referred to hereinafter as “second region teacher data”) for the second difference region data. The first learning image, the second learning image, the map data, the first difference region data, and the second region teacher data are associated with each other in terms of a location and a time point of the spatial region.

The second region teacher data is prepared in advance using the map data. For example, the second region teacher data is data indicating a location of the target object present in only one of the first map data and the second map data on the spatial region at substantially the same location, using an arrangement of polygons or images.

The model held in the second region learning unit 41 is a model provided with a network similar to a fully convolutional network, such as a U-Net that holds an encoder and a decoder. The network structure of the model held in the second region learning unit 41 may be, for example, a structure similar to the network structure described in Non Patent Literature 1. The model held in the second region learning unit 41 may include two encoders and a single decoder.

In the learning phase, the second region learning unit 41 acquires the first attribute data 301, the second attribute data 302, the first difference region data 300, and the second region teacher data. The model held in the second region learning unit 41 outputs estimated data (estimated change mask image) on the second difference region data 303, using the first attribute data 301, the second attribute data 302, the first difference region data 300, and the second region teacher data as input.

The second region learning unit 41 updates the parameters of the network of the model held in the second region learning unit 41 to minimize the evaluation error between the estimated data on the second difference region data 303 and the second region teacher data. The second region learning unit 41 updates the parameters using, for example, a back propagation method. The second region learning unit 41 outputs the model for which the parameters of the network have been updated, to the second region detection unit 13, as the second region model 130.

As described above, the difference detection apparatus 1a of the first embodiment includes the second region detection unit 13 (an acquisition unit and a detection unit). The second region detection unit 13 acquires a difference level, the first attribute data (first probability data), and the second attribute data (second probability data). The difference level indicates, for each pixel, the level of difference in pixel value between the first image 200 (the image of a first spatial region captured at a first time point) and the second image 201 (the image of a second spatial region captured at a second time point). The first attribute data indicates, for each pixel, a probability that the target object is included in the first spatial region in the first image 200 captured. The second attribute data indicates, for each pixel, a probability that the target object is included in the second spatial region in the second image 201 captured. The first attribute data and the second attribute data are generated, for example, based on the map data. The second region detection unit 13 associates the difference level, the first attribute data, and the second attribute data with each other. Here, this association is, for example, inputting, by the second region detection unit 13, the difference level, the first attribute data, and the second attribute data to the network (model) that outputs the difference region, in the machine learning. The association may also be associating, by the second region detection unit 13, the difference level, the first attribute data, and the second attribute data with each other, when the second region detection unit 13 executes signal processing determined based on heuristics for obtaining the difference region based on associating the difference level, the first attribute data, and the second attribute data. The difference level, the first attribute data, and the second attribute data can each be expressed as a probability value from 0 to 1. With the signal processing determined based on heuristics, for example, a weighted average of the pixel values (probability values of the elements) of the pixels, as the probability (final difference level) of the target object in the spatial region changing. With the signal processing determined based on heuristics, for example, a value as a result of multiplying a coefficient obtained in accordance with a difference between the first attribute data and the second attribute data by the difference level may be obtained as the probability (final difference level) of the target object in the spatial region changing. The second region detection unit 13 detects the difference region based on a result of the association (for example, input to the network).

Thus, the accuracy of detection of a difference region between images can be improved.

The first attribute data 301 and the second attribute data 302 are data generated by the difference detection apparatus 1a and is not data generated by manual labeling. Thus, the first attribute data 301 and the second attribute data 302 are highly accurate. The difference detection apparatus 1a can generate the first attribute data 301 and the second attribute data 302 in a short period of time.

When map data manually generated (for example, open source map data) includes an error, the difference detection apparatus 1a may correct the error in the manually generated map data using the first attribute data 301 and the second attribute data 302.

### MODIFIED EXAMPLE

An example of an estimation operation performed by the difference detection apparatus 1a without using a model such as a neural network will be described.

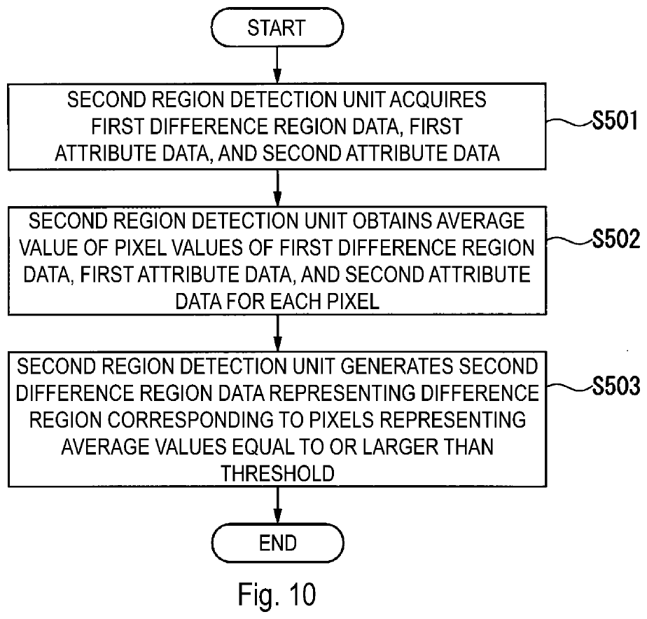

FIG. 10 is a flowchart illustrating an example of the estimation operation performed by the second region detection unit 13. The second region detection unit 13 acquires the first difference region data 300, the first attribute data 301, and the second attribute data 302 (step S501). The second region detection unit 13 obtains an average value of the pixel values of the first difference region data 300, the pixel value of the first attribute data 301, and the pixel value of the second attribute data 302 for each pixel associated with the same location in the captured images of the spatial region (step S502). The second region detection unit 13 generates the second difference region data 303 representing the difference region corresponding to pixels representing the average value equal to or larger than the threshold (step S503).

### Second Embodiment

The second embodiment is different from the first embodiment in that the first attribute data 301 is generated based on the map data and not based on images. In the second embodiment, differences from the first embodiment will be described.

The second region detection unit 13 may use the first attribute data 301 generated based on the map data as an input to generate the second difference region data 303.

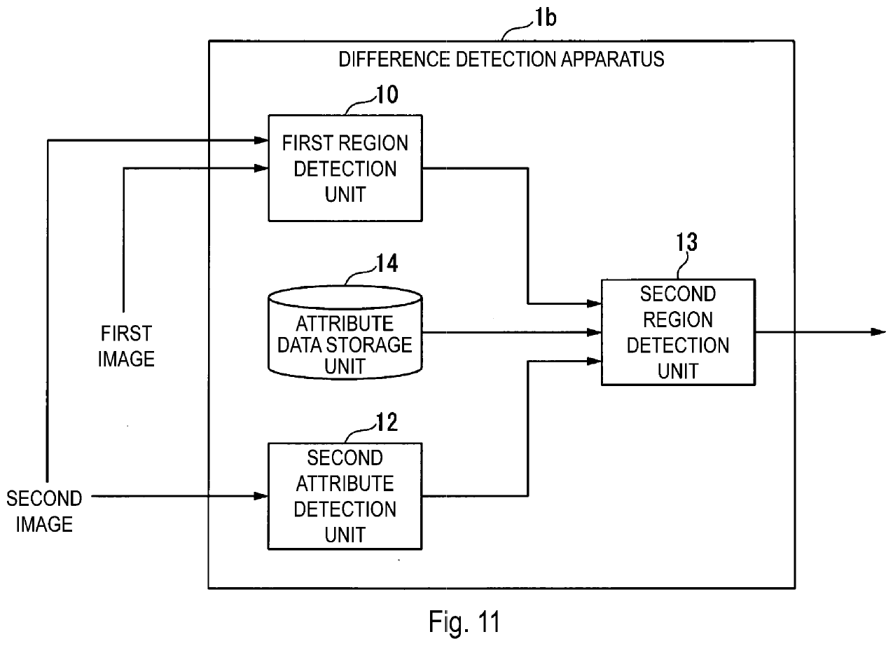

FIG. 11 is a diagram illustrating an example of a configuration of a difference detection apparatus 1b. The difference detection apparatus 1b is an information processing apparatus that detects a difference region between images. The difference detection apparatus 1b detects a difference region between images with, for example, a model using a neural network.

The difference detection apparatus 1b includes the first region detection unit 10, the second attribute detection unit 12, the second region detection unit 13, and an attribute data storage unit 14.

The attribute data storage unit 14 stores the first attribute data 301. The first attribute data 301 is generated in advance using map data (past actual attribute data) indicating the location of the target object in the captured image of the spatial region using an arrangement of polygons. The first attribute data 301 may be attribute teacher data stored in the attribute learning storage unit 30 illustrated in FIG. 8. The second region detection unit 13 acquires the first attribute data 301 from the attribute data storage unit 14.

Note that the attribute data storage unit 14 may store the first attribute data 301 and the second attribute data 302. The second region detection unit 13 may acquire the second attribute data 302 from the attribute data storage unit 14.

As described above, the difference detection apparatus 1b according to the second embodiment includes the attribute data storage unit 14. The attribute data storage unit 14 stores the first attribute data 301. The first attribute data 301 is generated in advance using map data (past actual attribute data). The second region detection unit 13 acquires the first attribute data 301 from the attribute data storage unit 14.

With this configuration, the difference region between images can be more accurately detected using the map data (past actual attribute data).

### Third Embodiment

A third embodiment is different from the first embodiment and the second embodiment in that a difference is detected based on the attribute data prepared in advance for the first image and the estimated value of attribute data on the second image. In the third embodiment, differences from the first embodiment and the second embodiment will be described.

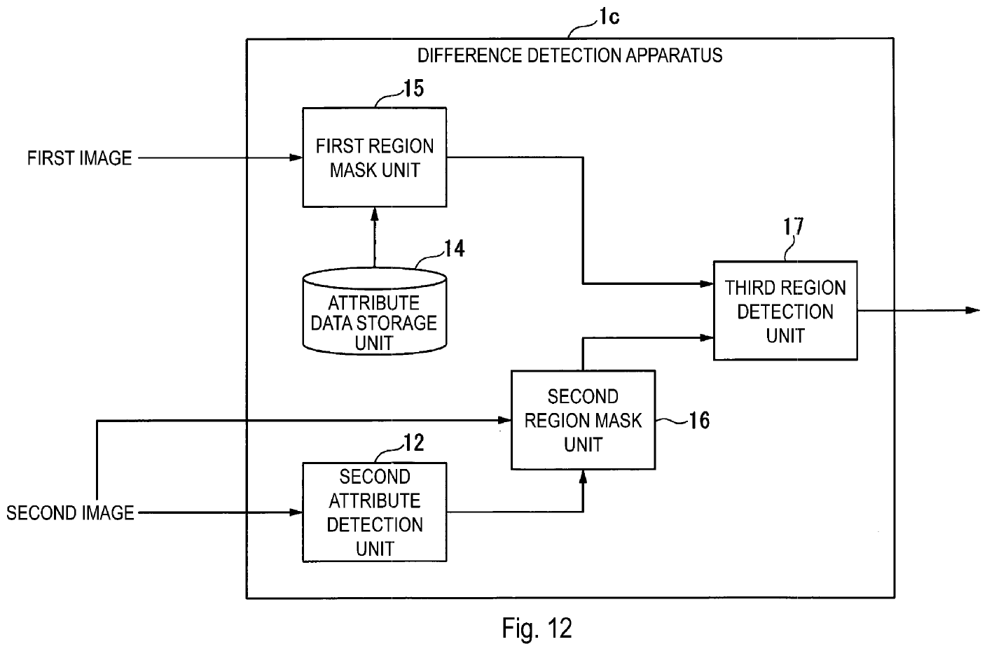

FIG. 12 is a diagram illustrating an example of a configuration of a difference detection apparatus 1c. The difference detection apparatus 1c is an information processing apparatus that detects a difference region between images. The difference detection apparatus 1c detects a difference region between images with, for example, a model using a neural network.

In the third embodiment, the difference region between the first image and the second image is detected based on attribute data prepared in advance for the first image and an estimated value of the attribute data on the second image. Thus, the attribute data prepared in advance for the first image is obtained for each pixel. The attribute data is used as a pixel value. The attribute data may be converted to pixel values through image conversion processing. An estimated value of the attribute data of the second image is obtained for each pixel of the second image. The estimated value of the attribute data is used as the pixel value. The estimated value of the attribute data may be converted to pixel values through image conversion processing.

In the third embodiment, the attribute data corresponding to the first image and the estimated value of the attribute data corresponding to the second image are target data for determining the difference region. Thus, the difference detection apparatus 1c can detect the difference region between the first image and the second image based on the attribute data.

The difference detection apparatus 1c includes the second attribute detection unit 12, the attribute data storage unit 14, a first region mask unit 15, a second region mask unit 16, and a third region detection unit 17.

The attribute data storage unit 14 stores the first attribute data 301. The first attribute data 301 is generated in advance using map data (past actual attribute data) indicating the location of the target object in the captured image of the spatial region using an arrangement of polygons. The first attribute data 301 may be attribute teacher data stored in the attribute learning storage unit 30 illustrated in FIG. 8. The first region mask unit 15 acquires the first attribute data 301 from the attribute data storage unit 14.

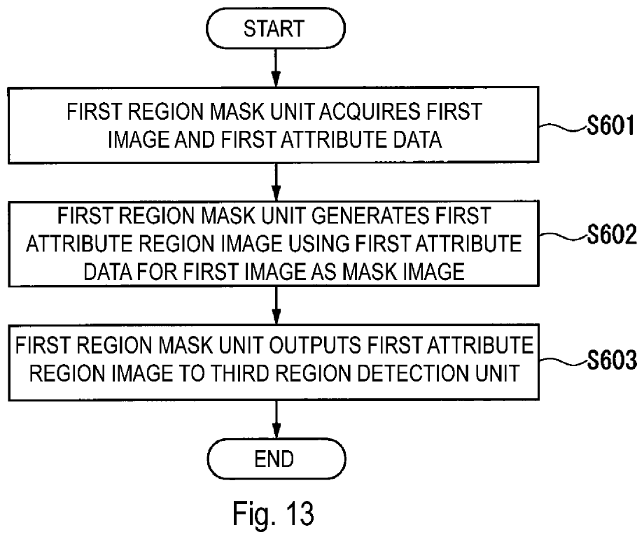

FIG. 13 is a flowchart illustrating an example of an operation performed by the first region mask unit 15. The first region mask unit 15 acquires the first image 200 and the first attribute data 301 (step S601). The first region mask unit 15 uses the first attribute data 301 (first probability data) for the first image 200 as the mask image, and generates a first attribute region image 400 (first probability image) as a result of the mask processing (step S602). The first region mask unit 15 outputs the first attribute region image 400 to the third region detection unit 17 (step S603).

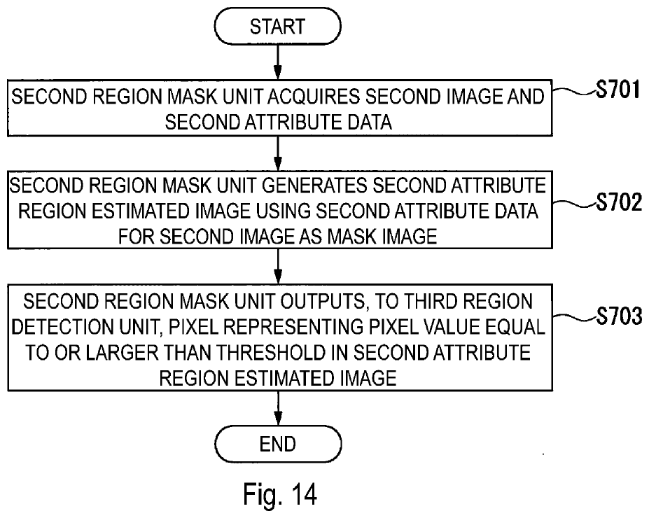

FIG. 14 is a flowchart illustrating an example of an operation performed by the second region mask unit 16. The second region mask unit 16 acquires the second image 201 and the second attribute data 302 (step S701). Here, this second attribute data 302 is attribute data estimated by the second attribute model 120 (estimated value of the probability data). The second attribute data 302 is expressed in the form of an image. The second attribute data 302 is obtained as a result of inputting the second image 201 to the second attribute detection unit 12. The range of each probability value corresponding to each pixel value in the second attribute data 302 is in a range from 0 to 1, as described in the first embodiment.

The second region mask unit 16 uses the second attribute data 302 for the second image 201 as the mask image, and generates a second attribute region estimated image 401 as a result of the mask processing (step S702). The second region mask unit 16 outputs, to the third region detection unit, a pixel indicating a pixel value equal to or larger than a threshold in the second attribute region estimated image (step S603). Here, the pixel value of the pixel indicating the pixel value smaller than the threshold value in the second attribute region estimated image 401 is replaced with 0.

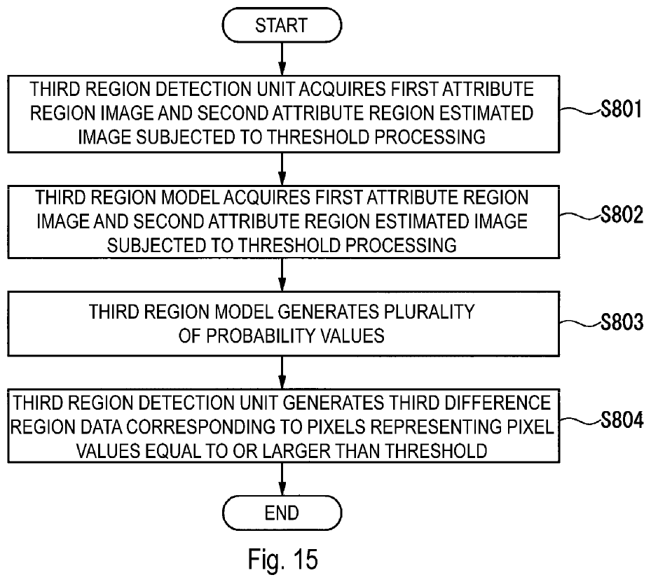

FIG. 15 is a flowchart illustrating an example of an estimation operation performed by the third region detection unit 17. The third region detection unit 17 acquires the first attribute region image 400 and the second attribute region estimated image 401 subjected to the threshold processing (step S801). The trained third region model 140 held in the third region detection unit 17 acquires the first attribute region image 400 and the second attribute region estimated image 401 subjected to the threshold processing (step S802).

The third region model 140 uses the pixel values of the first attribute region image 400 and the second attribute region estimated image 401 subjected to the threshold processing as input, and generates a plurality of probability values (output of the third region model 140, third difference region data). The number of probability values thus generated is equal to the number of pixels (size) of the first difference region data 300, for example (step S803).

The third region detection unit 17 generates third difference region data 304 corresponding to pixels with probability values or pixel values that are equal to or larger than the threshold (step S804). The threshold for the probability value is in a range from 0 to 1.

The third region model 140 is a model trained to use data as a combination of the first attribute region image 400 and the second attribute region estimated image 401 subjected to the threshold processing as input, and generate the third difference region data.

The third region model 140 and the second attribute model 120 can be trained independently from each other. The third region model 140 and the second region model may be trained as a single model instead of being trained independently from each other, with the second region mask unit 16 regarded as a unit (threshold rectified unit) using a normalized linear function with a threshold.

As described above, the difference detection apparatus 1c of the second embodiment includes the first region mask unit 15, the second region mask unit 16, and the third region detection unit 17. The first region mask unit 15 uses, as the mask image for the first image 200, the first attribute data 301 (first probability data) that is prepared in advance (generated in advance) and indicates a probability that the target object is present in the first spatial region. The first region mask unit 15 generates the first attribute region image 400 (first probability image), obtained as a result of the mask processing. The second region mask unit 16 uses, as the mask image for the second image 201, the second attribute data 302 (second probability data) indicating the estimated value of a probability that the target object is present in the second spatial region. The second region mask unit 16 generates the second attribute region estimated image 401 (second probability image), obtained as a result of the mask processing. The second region mask unit 16 may replace the pixel value of the pixel indicating the pixel value smaller than the threshold in the second attribute region estimated image 401 with 0. The third region detection unit 17 associates the first attribute region image 400 and the second attribute region estimated image 401 with each other. The third region detection unit 17 detects a region where a difference occurs between the first image 200 and the second image 201, based on the result of the association.

The embodiments of the present invention have been described above in detail with reference to the drawings. However, specific configurations are not limited to those embodiments, and include any design or the like within the scope not departing from the gist of the present invention.

### INDUSTRIAL APPLICABILITY

The present invention is applicable to an information processing apparatus (image processing apparatus) that detects a difference region between a plurality of images.

### REFERENCE SIGNS LIST

1a, 1b, 1c Difference detection apparatus
10 First region detection unit
11 First attribute detection unit
12 Second attribute detection unit
13 Second region detection unit
14 Attribute data storage unit
15 First region mask unit
16 Second region mask unit
17 Third region detection unit
20 First learning storage unit
21 First region learning unit
30 Attribute learning storage unit
31 Attribute learning unit
40 Second learning storage unit
41 Second region learning unit
100 First region model
110 First attribute model
120 Second attribute model
130 Second region model
140 Third region model
200 First image
201 Second image
300 First difference region data
301 First attribute data
302 Second attribute data
303 Second difference region data
304 Third difference region data
400 First attribute region image
401 Second attribute region estimated image

1. A difference detection apparatus, comprising:
a processor; and
a storage medium having computer program instructions stored thereon, when executed by the processor, perform to:
acquire a difference level indicating a level of a difference between a first image that is an image of a first spatial region and a second image that is an image of a second spatial region located at a substantially same position as the first spatial region, first probability data indicating a probability that a target object is present in the first spatial region, and second probability data indicating a probability that the target object is present in the second spatial region; and
associate the difference level, the first probability data, and the second probability data, and detect, based on a result of the association, a region where a difference occurs between the first image and the second image.

2. The difference detection apparatus according to claim 1, wherein the computer program instructions further perform to detects, as a region where the difference occurs, a region where a difference between the first probability data and the second probability data is equal to or larger than a threshold in the first image and the second image.

3. The difference detection apparatus according to claim 1 2, wherein the computer program instructions further perform to detects, as the region where the difference occurs, a region where the difference level is equal to or larger than a certain value in the first image and the second image.

4. The difference detection apparatus according to claim 1, wherein the computer program instructions further perform to
inputs the difference level, the first probability data, and the second probability data to a trained neural network, and
the trained neural network outputs the region where the difference occurs.

5. A difference detection apparatus, comprising:
a processor; and
a storage medium having computer program instructions stored thereon, when executed by the processor, perform to:
a first region mask unit configured to generate a first probability image that is an image obtained as a result of mask processing performed on a first image that is an image of a first spatial region by using, as a mask image, first probability data that is prepared in advance and indicates a probability that a target object is present in the first spatial region;
a second region mask unit configured to generate a second probability image that is an image obtained as a result of mask processing performed on a second image that is an image of a second spatial region located at a substantially same position as the first spatial region by using, as a mask image, second probability data that indicates an estimated value of a probability that the target object is present in a second spatial region; and
a detection unit configured to associate the first probability data and the second probability data, and detect, based on a result of the association, a region where a difference occurs between the first image and the second image.

6. A difference detection method performed by a difference detection apparatus, the difference detection method comprising:
acquiring a difference level indicating a level of a difference between a first image that is an image of a first spatial region and a second image that is an image of a second spatial region located at a substantially same position as the first spatial region, first probability data indicating a probability that a target object is present in the first spatial region, and second probability data indicating a probability that the target object is present in the second spatial region; and
associating the difference level, the first probability data, and the second probability data, and detecting, based on a result of the association, a region where a difference occurs between the first image and the second image.

7. A non-transitory computer-readable medium having computer-executable instructions that, upon execution of the instructions by a processor of a computer, cause the computer to function as the difference detection apparatus according to claim 1.
